(19) United States
(12) Patent Application Publication
(10) Pub. No.: US 2014/0125144 A1
(43) Pub. Date: May 8, 2014

(54) POWER TRANSMITTING DEVICE, POWER RECEIVING DEVICE, VEHICLE, AND CONTACTLESS POWER SUPPLY SYSTEM AND CONTROL METHOD FOR CONTACTLESS POWER SUPPLY SYSTEM

(71) Applicants: Toru Nakamura, Toyota-shi (JP); Shinji Ichikawa, Toyota-shi (JP); Kouji Nakamura, Toyota-shi (JP); Yukihiro Yamamoto, Kariya-shi (JP); Hiroshi Katsunaga, Kariya-shi (JP)

(72) Inventors: Toru Nakamura, Toyota-shi (JP); Shinji Ichikawa, Toyota-shi (JP); Kouji Nakamura, Toyota-shi (JP); Yukihiro Yamamoto, Kariya-shi (JP); Hiroshi Katsunaga, Kariya-shi (JP)

(73) Assignee: TOYOTA JIDOSHA KABUSHIKI KAISHA, Toyota-shi, Aichi-ken (JP)

(21) Appl. No.: 14/125,854

(22) PCT Filed: Jun. 14, 2012
(86) PCT No.: PCT/IB2012/001155

§ 371 Date: Dec. 12, 2013

(30) Foreign Application Priority Data
Jun. 17, 2011 (JP) 2011-135012

(51) Int. Cl. H02J 17/00

(52) U.S. Cl. CPC H02J 17/00
USPC 307/104

(57) ABSTRACT

In control over a contactless power supply system that includes: a power transmitting device that includes a power transmitting unit, a power supply unit supplying electric power to the power transmitting unit and a matching transformer coupled between the power supply unit and the power transmitting unit and including a variable inductor and a variable capacitor that adjust an impedance of the power transmitting device; and a power receiving device that includes a power receiving unit carrying out electromagnetic resonance with the power transmitting unit to contactlessly receive electric power from the power transmitting unit, before starting transfer of electric power from the power transmitting device to the power receiving device, the variable inductor is adjusted on the basis of an impedance of the power receiving device to thereby bring the impedance of the power transmitting device close to the impedance of the power receiving device.

### BACKGROUND OF THE INVENTION

1. Field of the Invention

The invention relates to a power transmitting device, a power receiving device, a vehicle, a contactless power supply system and a control method for contactless power supply system and, more particularly, to a contactless power supply technique for transferring electric power using electromagnetic resonance.

2. Description of Related Art

Vehicles, such as electric vehicles and hybrid vehicles, become a focus of attention as environmentally friendly vehicles. These vehicles each include an electric motor that generates running driving force and a rechargeable electrical storage device that stores electric power supplied to the electric motor. Note that the hybrid vehicles include a vehicle that further includes an internal combustion engine together with an electric motor as a power source, a vehicle that further includes a fuel cell together with an electrical storage device as a direct-current power supply for driving the vehicle, and the like.

In recent years, wireless power transmission that does not use a power cord or a power transmission cable becomes a focus of attention as a method of transmitting electric power from a power supply outside a vehicle to such a vehicle. Three leading techniques are known as the wireless power transmission technique. The three leading techniques are power transmission using electromagnetic induction, power transmission using electromagnetic wave such as a microwave and power transmission using a resonance method.

The resonance method is a contactless power transmission technique such that a pair of resonators (for example, a pair of resonance coils) are resonated in an electromagnetic field (near field) to thereby transmit electric power via the electromagnetic field. The resonance method is able to transmit large electric power of several kilowatts over a relatively long distance (for example, several meters).

Japanese Patent Application Publication No. 2010-141976 (JP 2010-141976 A) describes a contactless power transfer system that transfers electric power using electromagnetic resonance, in which a variable impedance circuit formed of a fixed inductor and a variable capacitor is provided between an alternating-current power supply and a primary coil and the impedance adjacent to the alternating-current power supply with respect to the primary coil is adjusted so as to be matched to an input impedance of a resonance system at a resonance frequency on the basis of a detected state of the resonance system.

With the configuration described in JP 2010-141976 A, when the distance between resonance coils or a load varies from a reference value at the time when the resonance frequency is set, reflected power to the alternating-current power supply is reduced to make it possible to efficiently supply electric power from the alternating-current power supply to the load even when the frequency of alternating-current output voltage of the alternating-current power supply is not varied.

Generally, when contactless power supply is carried out, the impedance of a secondary side (load side) with respect to a primary side (power supply side) varies depending on the state of the secondary-side load (for example, a battery capacity or a battery voltage). Particularly, in power supply to a vehicle, or the like, that is equipped with a large-capacity battery, the specification of an equipped battery may significantly vary among vehicles, so the fluctuation range of the impedance can also increase. Therefore, in order to efficiently carry out power transfer to various vehicles as many as possible, it is necessary to increase an adjustable range within which impedance matching is performed between the primary side and the secondary side.

In the configuration described in JP 2010-141976 A, the impedance may be matched to the variable impedance of the secondary side; however, when its adjustable range is intended to be increased, it is necessary to increase the capacitance and variable range of the variable capacitor.

When the impedance of the primary side and the impedance of the secondary side are adjusted during power supply operation, a method in which the impedance of each element is scanned over the entire adjustable range and then the impedance having the maximum efficiency is selected may be employed. In such a case, when an element having a large variable range is used, a scanning time, that is, an impedance adjustment time, extends, so a battery charging time may extend or a decrease in efficiency during impedance adjustment may be led.

### SUMMARY OF THE INVENTION

The invention provides a power transmitting device, a power receiving device, a vehicle, a contactless power supply system or a control method for contactless power supply system that transfers electric power using electromagnetic resonance, and that appropriately adjusts an impedance between a power transmitting device and a power receiving device to thereby improve power transfer efficiency.

A first aspect of the invention relates to a power transmitting device for contactlessly transferring electric power to a power receiving device through electromagnetic resonance. The power transmitting device includes: a power transmitting unit that carries out electromagnetic resonance with a power receiving unit included in the power receiving device to transfer electric power; a power supply unit that supplies electric power to the power transmitting unit; a matching transformer that is coupled between the power supply unit and the power transmitting unit and that includes a variable inductor and a variable capacitor that adjust an impedance of the power transmitting device; and a control unit that controls the matching transformer. The control unit controls the matching transformer to bring the impedance of the power transmitting device close to the impedance of the power receiving device by adjusting the variable inductor, before starting transfer of electric power, on the basis of a signal which indicates an impedance of the power receiving device and which is transmitted from the power receiving device.

In the power transmitting device, the variable inductor may be connected in series with the power transmitting unit and the power supply unit between the power transmitting unit and the power supply unit.

In the power transmitting device, the variable capacitor may be connected in parallel with the power transmitting unit and the power supply unit between the power transmitting unit and the power supply unit.

In the power transmitting device, during transfer of electric power, the control unit may adjust the variable capacitor in response to a variation in the impedance of the power receiving device to control the matching transformer so as to match the impedance of the power transmitting device to the impedance of the power receiving device.

In the power transmitting device, the matching transformer may have first and second capacitors as the variable capacitor, the variable inductor may be connected between the power transmitting unit and the power supply unit, the first capacitor may be connected to a first end portion of the variable inductor, the first end portion is connected to the power transmitting unit, the second capacitor may be connected to a second end portion of the variable inductor, and the second end portion is connected to the power supply unit.

In the power transmitting device, the matching transformer may include a third capacitor that is provided in parallel with the first capacitor and that is configured to be selectively connected to the first capacitor.

In the power transmitting device, the matching transformer may include a switch that is connected in series with the third capacitor and that connects or disconnects the third capacitor connected in parallel with the first capacitor.

In the power transmitting device, the control unit may transmit a first signal that indicates completion of the adjustment to the power receiving device when adjustment of the variable inductor has been completed, and the power receiving device may output a second signal, which indicates instructions to start transfer of electric power, to the power transmitting device after receiving the first signal.

In the power transmitting device, the matching transformer may include a switching unit that switches an inductance of the variable inductor.

A second aspect of the invention relates to a power receiving device for contactlessly receiving electric power, transferred from a power transmitting device, through electromagnetic resonance, the power transmitting device including a power transmitting unit; a power supply unit that supplies electric power to the power transmitting unit; and a matching transformer that is coupled between the power supply unit and the power transmitting unit and that has a variable inductor and a variable capacitor for adjusting an impedance of the power transmitting device. The power receiving device includes: a power receiving unit that carries out electromagnetic resonance with the power transmitting unit to receive electric power from the power transmitting device; an electrical storage device that is charged with the received electric power; and a control unit that controls charging operation for charging the electrical storage device, wherein the control unit outputs a signal that indicates an impedance of the power receiving device to the power transmitting device, and causes the power transmitting device to adjust the matching transformer so as to bring the impedance of the power transmitting device close to the impedance of the power receiving device by adjusting the variable inductor before starting transfer of electric power from the power transmitting device.

A third aspect of the invention relates to a vehicle. The vehicle includes: the above described power receiving device; and a driving device that uses electric power from the above described electrical storage device to generate running driving force.

A fourth aspect of the invention relates to a contactless power supply system for contactlessly transferring electric power through electromagnetic resonance. The contactless power supply system includes: a power transmitting device that includes a power transmitting unit; a power receiving device that includes a power receiving unit that carries out electromagnetic resonance with the power transmitting unit; and a control unit that controls transfer of electric power from the power transmitting device to the power receiving device, wherein the power transmitting device includes a power supply unit that supplies electric power to the power transmitting unit and a matching transformer that is coupled between the power supply unit and the power transmitting unit and that includes a variable inductor and a variable capacitor that adjust an impedance of the power transmitting device, and the control unit controls the matching transformer to bring the impedance of the power transmitting device close to the impedance of the power receiving device by adjusting the variable inductor, before starting transfer of the electric power, on the basis of a signal that indicates an impedance of the power receiving device and that is transmitted from the power receiving device.

A fifth aspect of the invention relates to a control method for a contactless power supply system that includes: a power transmitting device that includes a power transmitting unit; a power supply unit that supplies electric power to the power transmitting unit; and a matching transformer that, is coupled between the power supply unit and the power transmitting unit and that includes a variable inductor and a variable capacitor that adjust an impedance of the power transmitting device; and a power receiving device that includes a power receiving unit that carries out electromagnetic resonance with the power transmitting unit to contactlessly receive electric power from the power transmitting unit. The control method includes: before starting transfer of electric power from the power transmitting device to the power receiving device, bringing the impedance of the power transmitting device close to the impedance of the power receiving device by adjusting the variable inductor on the basis of an impedance of the power receiving device.

According to the aspects of the invention, it is possible to provide a contactless power supply system that transfers electric power using electromagnetic resonance, and that appropriately adjusts an impedance between a power transmitting device and a power receiving device to thereby improve power transfer efficiency.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an overall schematic view of a power supply system for a vehicle according to a first embodiment of the invention;

FIG. 2 is a detailed configuration view of the power supply system shown in FIG. 1;

FIG. 3 is a view for illustrating the principle of power transmission using a resonance method;

FIG. 4 is a graph that shows the correlation between a distance from a current source (magnetic current source) and the strength of an electromagnetic field;

FIG. 5 is a detailed configuration view of a matching transformer in the first embodiment;

FIG. 6 is a view for illustrating impedance adjustment made by the matching transformer;

FIG. 7 is a view for illustrating impedance adjustment in the case where the matching transformer shown in FIG. 5 is used;

FIG. 8A,B is a flow chart for illustrating power supply control process executed by a power transmitting ECU and a vehicle ECU in the first embodiment;

FIG. 9 is a view for illustrating an example of impedance adjustment in the case where the imaginary part of a load impedance is large; and

FIG. 10 is a detailed configuration view of a matching transformer according to a second embodiment.

### DETAILED DESCRIPTION OF EMBODIMENTS

Hereinafter, embodiments of the invention will be described in detail with reference to the accompanying drawings. Note that like reference numerals denote the same or corresponding components in the drawings, and the description thereof is not repeated.

### First Embodiment

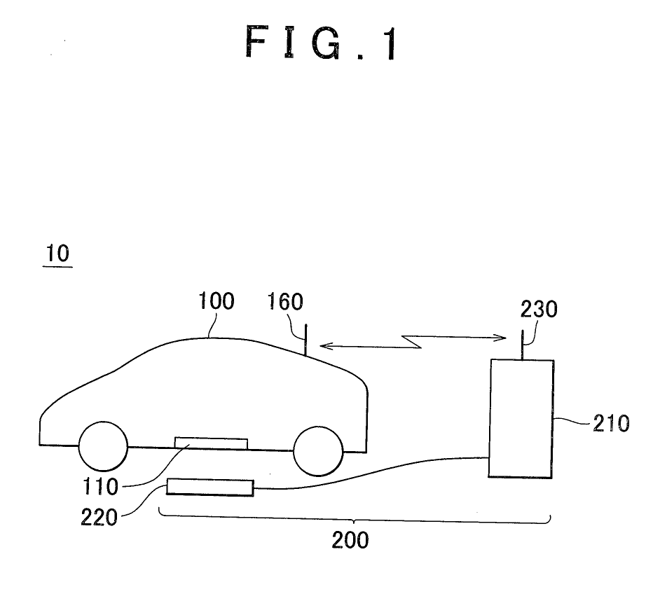

FIG. 1 is an overall schematic view of a power supply system 10 for a vehicle according to a first embodiment of the invention. As shown in FIG. 1, the power supply system 10 includes a vehicle 100 and a power transmitting device 200. The vehicle 100 includes a power receiving unit 110 and a communication unit 160. The power transmitting device 200 includes a power supply device 210 and a power transmitting unit 220. In addition, the power supply device 210 includes a communication unit 230.

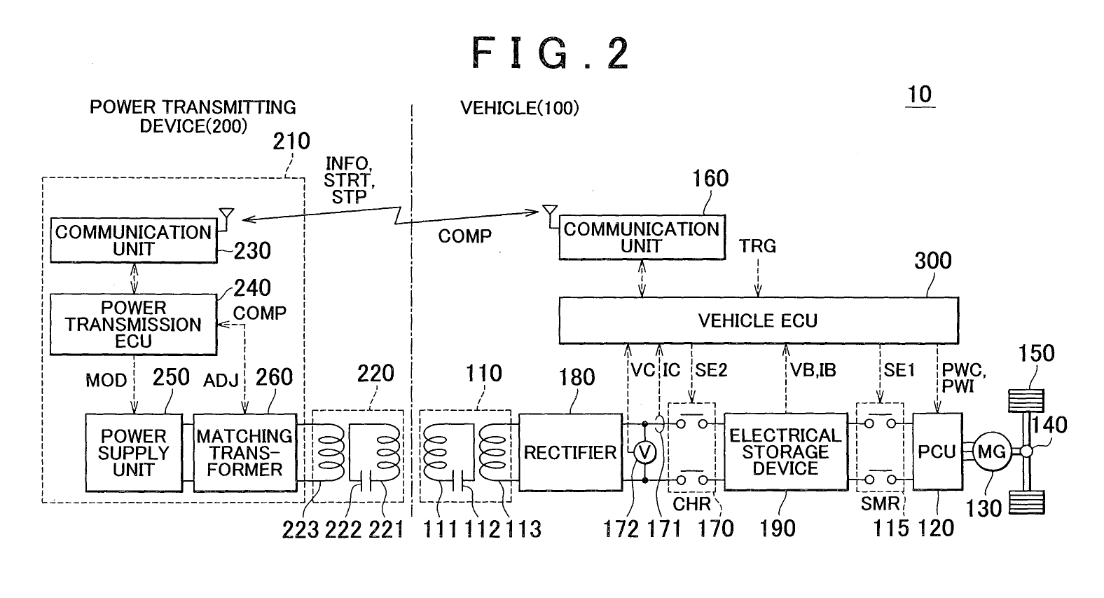

The power receiving unit 110 is, for example, provided at a vehicle bottom face, and is configured to contactlessly receive electric power transmitted from the power transmitting unit 220 of the power transmitting device 200. More specifically, as will be described in FIG. 2, the power receiving unit 110 includes a resonance coil, and resonates with a resonance coil, included in the power transmitting unit 220, using an electromagnetic field to thereby contactlessly receive electric power from the power transmitting unit 220. The communication unit 160 is a communication interface for carrying out wireless communication between the vehicle 100 and the power transmitting device 200.

The power supply device 210 of the power transmitting device 200, for example, converts alternating-current power, supplied from a commercial power supply, to high-frequency electric power and then outputs the high-frequency electric power to the power transmitting unit 220. Note that the frequency of high-frequency electric power generated by the power supply device 210 is, for example, 1 MHz to several tens of MHz.

The power transmitting unit 220 is provided on a floor surface of a parking lot, or the like, and is configured to contactlessly transmit high-frequency electric power, supplied from the power supply device 210, to the power receiving unit 110 of the vehicle 100. More specifically, the power transmitting unit 220 includes the resonance coil, and resonates with the resonance coil, included in the power receiving unit 110, using an electromagnetic field to thereby contactlessly transmit electric power to the power receiving unit 110. The communication unit 230 is a communication interface for carrying out wireless communication between the power transmitting device 200 and the vehicle 100.

FIG. 2 is a detailed configuration view of the power supply system 10 shown in FIG. 1. As shown in FIG. 2, the vehicle 100 includes a rectifier 180, a charging relay (CHR) 170, an electrical storage device 190, a system main relay (SMR) 115, a power control unit (PCU) 120, a motor generator 130, a power transmission gear 140, drive wheels 150, a vehicle electronic control unit (ECU) 300 that serves as a control unit, a current sensor 171 and a voltage sensor 172 in addition to the power receiving unit 110 and the communication unit 160. The power receiving unit 110 includes a secondary resonance coil 111, a capacitor 112 and a secondary coil 113.

Note that, in the present embodiment, an electric vehicle is, for example, described as the vehicle 100; however, the configuration of the vehicle 100 is not limited to the electric vehicle as long as the vehicle is able to run using electric power stored in the electrical storage device. Another example of the vehicle 100 includes a hybrid vehicle equipped with an engine, a fuel cell vehicle equipped with a fuel cell, and the like.

The secondary resonance coil 111 receives electric power from a primary resonance coil 221, included in the power transmitting device 200, through electromagnetic resonance using an electromagnetic field.

The number of turns of the secondary resonance coil 111 is appropriately set on the basis of the distance from the primary resonance coil 221 of the power transmitting device 200, the resonance frequency between the primary resonance coil 221 and the secondary resonance coil 111, and the like, such that a Q value (for example, Q>100) that indicates resonance strength between the primary resonance coil 221 and the secondary resonance coil 111, κ that indicates the degree of coupling therebetween, and the like, increase.

The capacitor 112 is connected to both ends of the secondary resonance coil 111, and forms an LC resonance circuit together with the secondary resonance coil 111. The capacitance of the capacitor 112 is appropriately set so as to attain a predetermined resonance frequency on the basis of the inductance of the secondary resonance coil 111. Note that, when a desired resonance frequency is obtained by a stray capacitance of the secondary resonance coil 111 itself, the capacitor 112 may be omitted.

The secondary coil 113 is provided coaxially with the secondary resonance coil 111, and is able to be magnetically coupled to the secondary resonance coil 111 through electromagnetic induction. The secondary coil 113 extracts electric power, received by the secondary resonance coil 111, through electromagnetic induction and outputs the electric power to the rectifier 180.

The rectifier 180 rectifies alternating-current power received from the secondary coil 113, and outputs the rectified direct-current power to the electrical storage device 190 via the CHR 170. The rectifier 180 may be, for example, formed to include a diode bridge and a smoothing capacitor (both are not shown). The rectifier 180 may be a so-called switching regulator that rectifies alternating current using switching control; however, the rectifier 180 may be included in the power receiving unit 110, and, in order to prevent erroneous operation, or the like, of switching elements caused by a generated electromagnetic field, the rectifier 180 is desirably a static rectifier, such as a diode bridge.

Note that, in the present embodiment, direct-current power rectified by the rectifier 180 is directly output to the electrical storage device 190; however, when a rectified direct-current voltage differs from a charging voltage that is allowed by the electrical storage device 190, a DC/DC converter (not shown) for voltage conversion may be provided between the rectifier 180 and the electrical storage device 190.

The voltage sensor 172 is provided between a pair of power lines that connect the rectifier 180 to the electrical storage device 190. The voltage sensor 172 detects a secondary-side direct-current voltage of the rectifier 180, that is, a received voltage received from the power transmitting device 200, and then outputs the detected value VC to the vehicle ECU 300.

The current sensor 171 is provided in one of the power lines that connect the rectifier 180 to the electrical storage device 190. The current sensor 171 detects a charging current for charging the electrical storage device 190, and outputs the detected value IC to the vehicle ECU 300.

The CHR 170 is electrically connected to the rectifier 180 and the electrical storage device 190. The CHR 170 is controlled by a control signal SE2 from the vehicle ECU 300, and switches between supply and interruption of electric power from the rectifier 180 to the electrical storage device 190.

The electrical storage device 190 is an electric power storage element that is configured to be chargeable and dischargeable. The electrical storage device 190 is, for example, formed of a secondary battery, such as a lithium ion battery, a nickel-metal hydride battery and a lead-acid battery, or an electrical storage element, such as an electric double layer capacitor.

The electrical storage device 190 is connected to the rectifier 180 via the CHR 170. The electrical storage device 190 stores electric power that is received by the power receiving unit 110 and rectified by the rectifier 180. In addition, the electrical storage device 190 is also connected to the PCU 120 via the SMR 115. The electrical storage device 190 supplies electric power for generating vehicle driving force to the PCU 120. Furthermore, the electrical storage device 190 stores electric power generated by the motor generator 130. The output of the electrical storage device 190 is, for example, about 200 V.

A voltage sensor and a current sensor (both are not shown) are provided for the electrical storage device 190. The voltage sensor is used to detect the voltage VB of the electrical storage device 190. The current sensor is used to detect a current IB input to or output from the electrical storage device 190. These detected values are output to the vehicle ECU 300. The vehicle ECU 300 computes the state of charge (also referred to as “SOC”) of the electrical storage device 190 on the basis of the voltage VB and the current IB.

The SMR 115 is inserted in power lines that connect the electrical storage device 190 to the PCU 120. Then, the SMR 115 is controlled by a control signal SE1 from the vehicle ECU 300, and switches between supply and interruption of electric power between the electrical storage device 190 and the PCU 120.

The PCU 120 includes a converter and an inverter (both are not shown). The converter is controlled by a control signal PWC from the vehicle ECU 300, and converts voltage from the electrical storage device 190. The inverter is controlled by a control signal PWI from the vehicle ECU 300, and drives the motor generator 130 using electric power converted by the converter.

The motor generator 130 is an alternating-current rotating electrical machine, and is, for example, a permanent-magnet synchronous motor that includes a rotor in which a permanent magnet is embedded.

The output torque of the motor generator 130 is transmitted to the drive wheels 150 via the power transmission gear 140 to drive the vehicle 100. The motor generator 130 is able to generate electric power using the rotational force of the drive wheels 150 during regenerative braking operation of the vehicle 100. Then, the generated electric power is converted by the PCU 120 to charging electric power to charge the electrical storage device 190.

In addition, in a hybrid vehicle equipped with an engine (not shown) in addition to the motor generator 130, the engine and the motor generator 130 are cooperatively operated to generate required vehicle driving force. In this case, the electrical storage device 190 may be charged with electric power generated from the rotation of the engine.

As described above, the communication unit 160 is a communication interface for carrying out wireless communication between the vehicle 100 and the power transmitting device 200. The communication unit 160 outputs battery information INFO about the electrical storage device 190, including the SOC, from the vehicle ECU 300 to the power transmitting device 200. In addition, the communication unit 160 outputs a signal STRT or STP, which instructs the power transmitting device 200 to start or stop transmission of electric power, to the power transmitting device 200.

The ECU 300 includes a central processing unit (CPU), a storage unit and an input/output buffer, which are not shown in FIG. 1. The ECU 300 inputs signals from the sensors, and the like, outputs control signals to the devices, and controls the vehicle 100 and the devices. Note that control over the vehicle 100 and the devices are not only limited to processing by software but may also be processed by exclusive hardware (electronic circuit).

When the vehicle ECU 300 receives a charge start signal TRG through user's operation, or the like, the vehicle ECU 300 outputs the signal STRT for instructions to start transmission of electric power to the power transmitting device 200 via the communication unit 160 on the basis of the fact that a predetermined condition is satisfied. In addition, the vehicle ECU 300 outputs the signal STP for instructions to stop transmission of electric power to the power transmitting device 200 via the communication unit 160 on the basis of the fact that the electrical storage device 190 is fully charged, user's operation, or the like.

Note that the configuration of the vehicle 100, other than the SMR 115, the PCU 120, the motor generator 130, the power transmission gear 140 and the drive wheels 150 that form a “driving device”, may be regarded as a “power receiving device” according to the aspect of the invention.

As described above, the power transmitting device 200 includes the power supply device 210 and the power transmitting unit 220. The power supply device 210 further includes a power transmission ECU 240 that serves as a control unit, a power supply unit 250 and a matching transformer 260 in addition to the communication unit 230. In addition, the power transmitting unit 220 includes the primary resonance coil 221, a capacitor 222 and a primary coil 223.

The power supply unit 250 is controlled by a control signal MOD from the power transmission ECU 240, and converts electric power, received from the alternating-current power supply, such as a commercial power supply, to high-frequency electric power. Then, the power supply unit 250 supplies the converted high-frequency electric power to the primary coil 223 via the matching transformer 260. Note that the frequency of high-frequency electric power generated by the power supply unit 250 is, for example, 1 MHz to several tens of MHz.

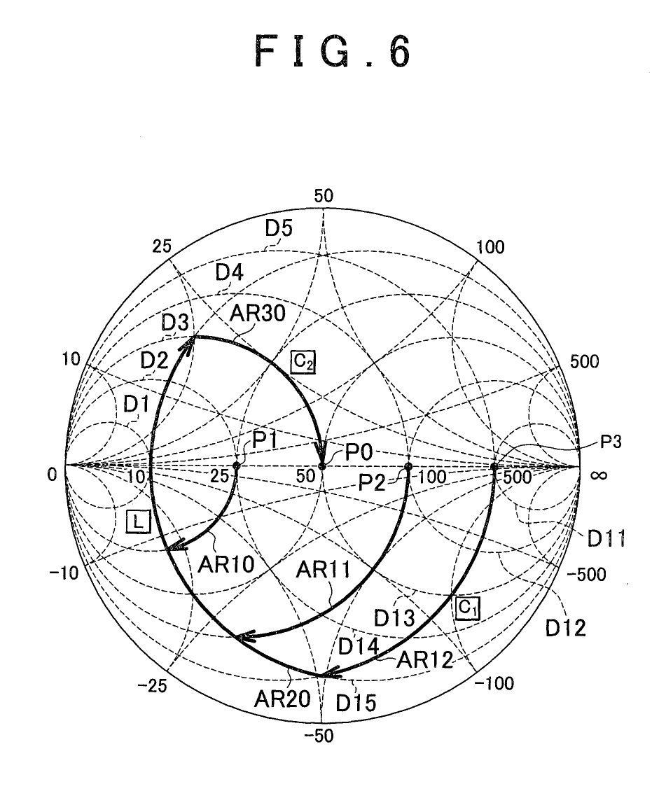

The matching transformer 260 is a circuit for matching impedance between the power transmitting device 200 and the vehicle 100. The details of the matching transformer 260 will be described later in FIG. 5 and is roughly configured to include a variable capacitor and a variable inductor. The matching transformer 260 is controlled by a control signal ADJ that is given from the power transmission ECU 240 on the basis of the battery information INFO transmitted from the vehicle 100, and the variable capacitor and the variable inductor are adjusted so as to match the impedance of the power transmitting device 200 to the impedance of the side of the vehicle 100. In addition, the matching transformer 260 outputs a signal COMP, which indicates completion of impedance adjustment, to the power transmission ECU 240.

The primary resonance coil 221 transfers electric power to the secondary resonance coil 111, included in the power receiving unit 110 of the vehicle 100, through electromagnetic resonance.

The number of turns of the primary resonance coil 221 is appropriately set on the basis of the distance from the secondary resonance coil 111 of the vehicle 100, the resonance frequency between the primary resonance coil 221 and the secondary resonance coil 111, and the like, such that a Q value (for example, Q>100) that indicates resonance strength between the primary resonance coil 221 and the secondary resonance coil 111, κ that indicates the degree of coupling therebetween, and the like, increase.

The capacitor 222 is connected to both ends of the primary resonance coil 221, and forms an LC resonance circuit together with the primary resonance coil 221. The capacitance of the capacitor 222 is appropriately set so as to attain a predetermined resonance frequency on the basis of the inductance of the primary resonance coil 221. Note that, when a desired resonance frequency is obtained by a stray capacitance of the primary resonance coil 221 itself, the capacitor 222 may be omitted.

The primary coil 223 is provided coaxially with the primary resonance coil 221, and is able to be magnetically coupled to the primary resonance coil 221 through electromagnetic induction. The primary coil 223 transmits high-frequency electric power, supplied through the matching transformer 260, to the primary resonance coil 221 through electromagnetic induction.

As described above, the communication unit 230 is a communication interface for carrying out wireless communication between the power transmitting device 200 and the vehicle 100. The communication unit 230 receives the battery information INFO and the signal STRT or STP for instructions to start or stop transmission of electric power, transmitted from the communication unit 160 of the vehicle 100, and outputs these pieces of information to the power transmission ECU 240. In addition, the communication unit 230 receives the signal COMP, which indicates completion of impedance adjustment from the matching transformer 260, from the power transmission ECU 240, and outputs the signal COMP to the vehicle 100.

The power transmission ECU 240 includes a CPU, a storage device and an input/output buffer (which are not shown in FIG. 1). The power transmission ECU 240 inputs signals from sensors, or the like, and outputs control signals to various devices to thereby control various devices in the power supply device 210. Note that control over the devices are not only limited to processing by software but may also be processed by exclusive hardware (electronic circuit).

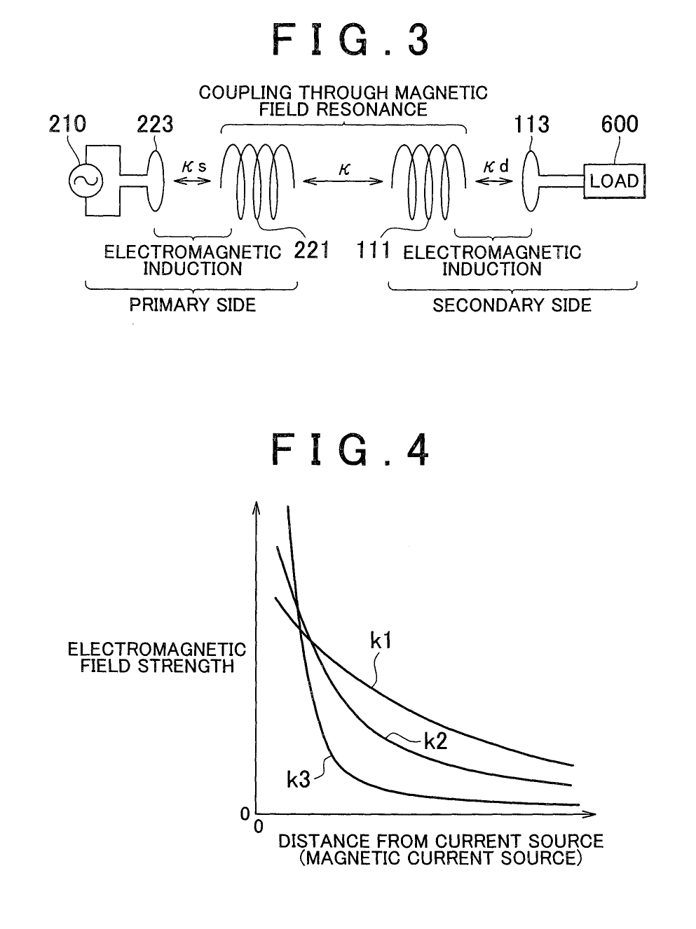

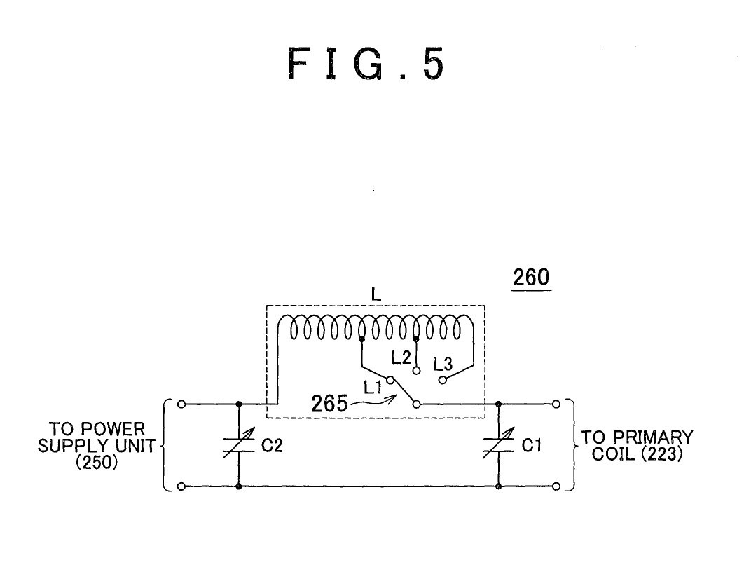

Next, contactless power supply through electromagnetic resonance (hereinafter, also referred to as resonance method) will be described with reference to FIG. 3 and FIG. 4.

FIG. 3 is a view for illustrating the principle of power transmission using a resonance method. As shown in FIG. 3, in this resonance method, as in the case where two tuning forks resonate with each other, two LC resonance coils having the same natural frequency resonate with each other in an electromagnetic field (near field) to thereby transfer electric power from one of the resonance coils to the other one of the resonance coils through the electromagnetic field.

Specifically, the primary coil 223 that is an electromagnetic induction coil is connected to the high-frequency power supply device 210, and high-frequency electric power having a frequency of 1 MHz to several tens of MHz is supplied to the primary resonance coil 221, magnetically coupled to the primary coil 223, through electromagnetic induction. The primary resonance coil 221 is an LC resonator formed of the inductance of the coil itself and the stray capacitance or the capacitor (not shown) connected to both ends of the coil, and resonates with the secondary resonance coil 111 using an electromagnetic field (near field) having the same natural frequency as the primary resonance coil 221. Then, energy (electric power) is transferred from the primary resonance coil 221 to the secondary resonance coil 111 via the electromagnetic field. Energy (electric power) transferred to the secondary resonance coil 111 is extracted through electromagnetic induction by the secondary coil 113, which is an electromagnetic induction coil magnetically coupled to the secondary resonance coil 111, and is supplied to a load 600. Power transmission using a resonance method is carried out when the Q value that indicates resonance strength between the primary resonance coil 221 and the secondary resonance coil 111 is, for example, larger than 100. Note that the load 600 in FIG. 3 corresponds to devices located downstream of the rectifier 180 in FIG. 2.

FIG. 4 is a graph that shows the correlation between a distance from a current source (magnetic current source) and the strength of an electromagnetic field. As shown in FIG. 4, the electromagnetic field includes three components. The curve k1 is a component inversely proportional to a distance from a wave source, and is referred to as “radiation field”. The curve k2 is a component inversely proportional to the square of a distance from a wave source, and is referred to as “induction field”. In addition, the curve k3 is a component inversely proportional to the cube of a distance from a wave source, and is referred to as “static field”.

Among these, there is a region in which the strength of electromagnetic field steeply reduces with a distance from a wave source, and, in a resonance method, this near field (evanescent field) is utilized to transfer energy (electric power). That is, by resonating a pair of resonators (for example, a pair of LC resonance coils) having the same natural frequency utilizing a near field, energy (electric power) is transferred from one resonator (primary resonance coil) to the other resonator (secondary resonance coil). This near field does not propagate energy (electric power) to a far place, so, in comparison with an electromagnetic wave that transfers energy (electric power) by the “radiation field” that propagates energy to a far place, the resonance method is able to transmit electric power with a less energy loss.

In the above power supply system that transfers electric power at a high frequency, the transfer efficiency of electric power is influenced by the impedance of the power transmission side and the impedance of the power receiving side. In the configuration shown in FIG. 2, when the electrical storage device mounted on the vehicle is charged, the impedance varies depending on the type and specification (capacitance, voltage, internal resistance, and the like) of the mounted electrical storage device. In addition, even in the same electrical storage device, the impedance varies depending on the amount of charge.

Therefore, it is necessary to appropriately match the impedance on the basis of a different electrical storage device and the state of charge of the electrical storage device. In order to achieve this subject, as shown in FIG. 2, a matching transformer for matching the impedance may be provided.

In such a matching transformer, at the time of matching the impedance, generally, a method in which the impedance of the matching transformer is scanned over the entire variable range to search for an impedance at which the efficiency is maximum is used. In this case, in order to handle many types of vehicles having different impedances, it is necessary to increase the variable range of the impedance, so an adjustment time for scanning an impedance extends and, as a result, a charging time can extend.

In addition, when impedance adjustment is performed while charging is performed, power transfer is carried out at a low transfer efficiency until impedance adjustment is completed.

Then, in the first embodiment, the power supply system that the matching transformer having the variable inductor and the variable capacitor is used to reduce a period of time for impedance matching to thereby make it possible to improve the transfer efficiency of electric power will be described.

FIG. 5 is a detailed configuration view of the matching transformer 260 according to the first embodiment. As shown in FIG. 5, the matching transformer 260 includes variable capacitors C1 and C2 and a variable inductor L.

The variable inductor L is connected between the power supply unit 250 and the power transmitting unit 220. The variable capacitor C1 is connected to an end portion of the variable inductor L, which is connected to the power transmitting unit 220. In addition, the variable capacitor C2 is connected to an end portion of the variable inductor L, which is connected to the power supply unit 250.

The variable inductor L has a plurality of taps having different inductances, such as three switching taps L1 to L3 shown in FIG. 5. Then, the variable inductor L switches among the taps by a selector 265 to change the inductance.

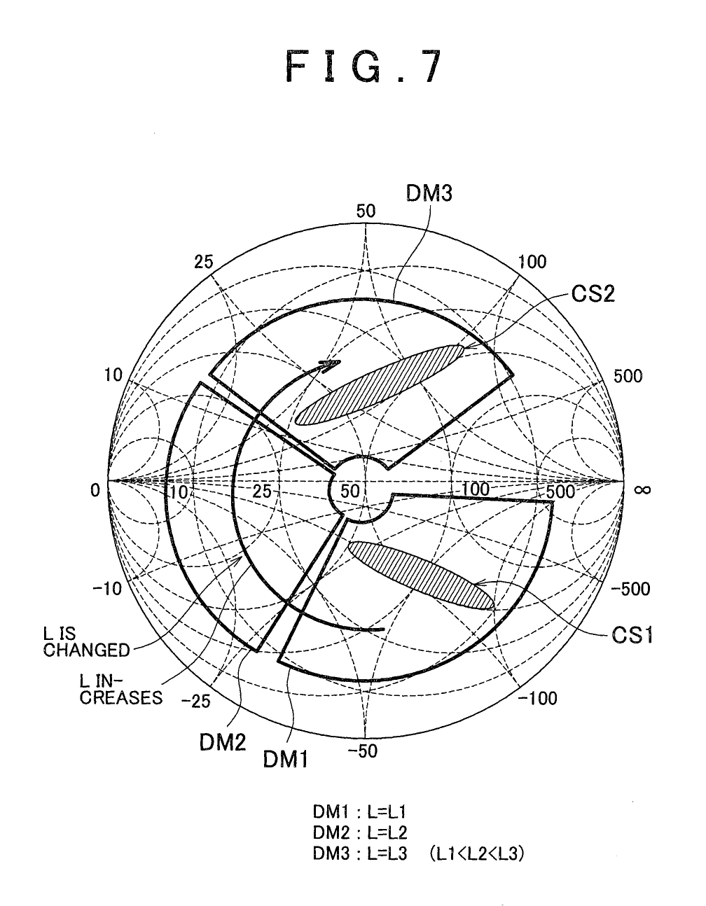

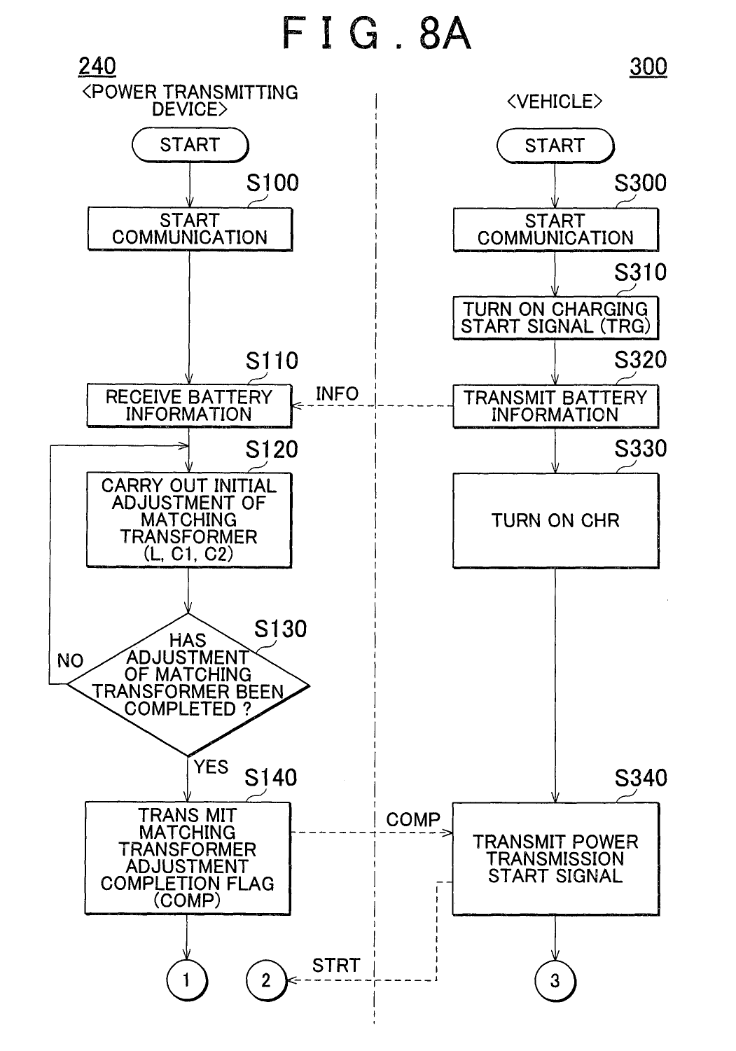

A method of adjusting the impedance in the above matching transformer will be described in more detail with reference to FIG. 6 and FIG. 7.

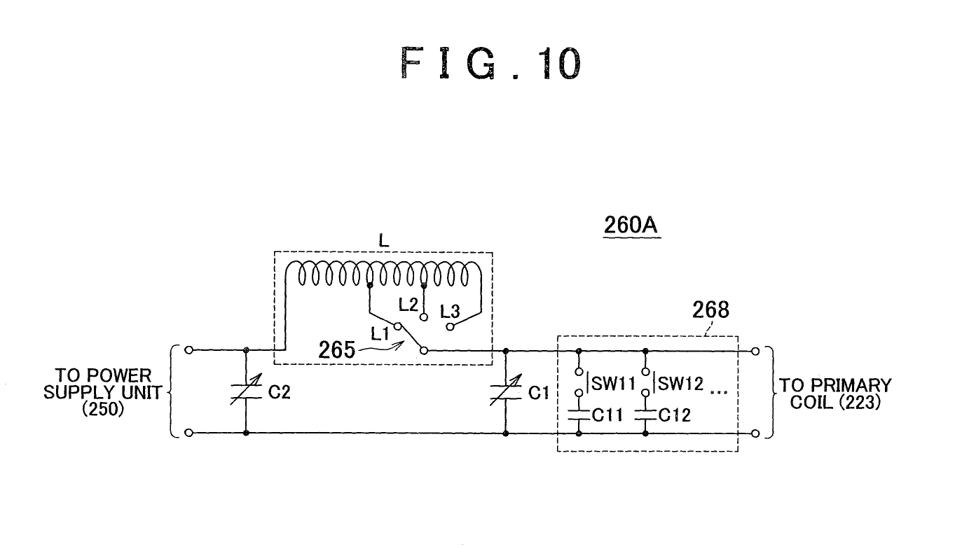

FIG. 6, FIG. 7 and FIG. 10 (described later) each are a circular graph, called Smith chart, that indicates a complex impedance used to design impedance matching. The horizontal axis of the Smith chart indicates the real part of a complex impedance, the left end of the horizontal axis indicates 0Ω (short-circuit), and the right end of the horizontal axis indicates∞Ω (open-circuit). In addition, the vertical axis indicates the imaginary part of a complex impedance. Using this Smith chart, generally, a capacitor and an inductor are adjusted so as to attain the center PO of the circle, that is, an impedance of 50Ω.

In the Smith chart, when a capacitor is connected in parallel with a certain load, the impedance varies along the circumference of a circle (for example, a circle D1, D2, D3, D4 or D5 in FIG. 6) that is tangent to the left end (0Ω) of the horizontal axis in the clockwise direction (CW direction) on the basis of the capacitance of the capacitor. In addition, when the inductor is connected in series with the load, the impedance varies along the circumference of a circle (for example, a circle D11, D12, D13, D14 or D15 in FIG. 6) that is tangent to the right end (∞Ω) of the horizontal axis in the CW direction on the basis of the inductance.

In the matching transformer 260 shown in FIG. 5, for example, it is assumed that the load has a pure resistance of 500Ω (P3 in FIG. 6). At this time, the impedance varies as shown in the arrow AR12 in FIG. 6 because of the variable capacitor C1. Then, the impedance varies as shown in the arrow AR20 by the variable inductor L. Furthermore, the impedance varies as shown in the arrow AR30 because of the variable capacitor C2, and finally reaches point P0. In this way, the capacitances of the variable capacitors C1 and C2 and the inductance of the variable inductor L are appropriately adjusted on the basis of the impedance of the load to thereby make it possible to match impedance between the power transmitting device 200 and the vehicle 100.

The inductance increases with an increase in the length (number of turns) of the coil. Therefore, it is not so easy to continuously vary the inductance, and, generally, a method for varying the inductance discretely as in the case of the variable inductor L shown in FIG. 5 is used. On the other hand, it is possible to discretely vary the inductance with a relatively simple structure, so it is advantageous that the overall variation range of the inductance may be set so as to be large.

In contrast to this, the capacitor is able to vary its capacitance by varying a facing area between the electrodes, so it is relatively easy to continuously vary the capacitance. However, a large-capacitance capacitor is relatively expensive, and, at present, there is a small number of types of large-capacitance capacitor that has a favorable characteristic at high frequencies.

Then, in the present embodiment, the variable inductor L is used as an actuator for roughly adjusting the impedance before start of power transmission, and the variable capacitors C1 and C2 are used as an actuator for finely dynamically adjusting a varying impedance during power transmission.

FIG. 7 is a graph for illustrating impedance adjustment according to the first embodiment in the case where the matching transformer shown in FIG. 5 is used. In FIG. 7, the fan-shaped region DM1, DM2 or DM3 indicates a region in which the impedance may be matched using the variable capacitors C1 and C2 when the inductance of the variable inductor L is fixed at L1, L2 or L3. In other words, when the impedance of the load (that is, vehicle side) varies within the range of the region DM1 as in the case of the range CS1 in FIG. 7, the inductance of the variable inductor L is set at L1, and, for a varying impedance that varies with the progress of charging, only the variable capacitors C1 and C2 are varied to thereby make it possible to match the impedance.

In addition, as another example, when the impedance of the load varies within the range of the region DM3 as in the case of the range CS2, the inductance of the variable inductor L is set at L3 to thereby make it possible to match varying impedance during charging only by the variable capacitors C1 and C2.

In this way, the variable inductor L is adjusted in advance before start of power transmission such that the variation range of the impedance against a variation in the amount of charge (that is, SOC) of the electrical storage device 190 mounted on the vehicle 100 is adjustable only by the variable capacitors C1 and C2. Thus, it is not necessary to scan over the entire impedance adjustment range during power transmission operation, and it is possible to carry out only fine adjustment (minute adjustment) using the variable capacitors C1 and C2. By so doing, it is possible to reduce the impedance adjustment time, and it is possible to reduce a charging time and improve charging efficiency.

Note that the example in which the number of switching taps of the variable inductor L is three is described in FIG. 5 and FIG. 7; however, the number of switching taps is not limited to this configuration, it may be larger or smaller. When the number of switching taps is reduced, it is necessary to increase the adjustment range (fan-shaped range in FIG. 7) of the variable capacitors C1 and C2, so it is easy to handle the case where the fluctuation range of the impedance of the load is large; however, it is necessary to increase the capacitance of each capacitor in order to cover a wider region by the variable capacitors C1 and C2.

On the other hand, when the number of switching taps is increased, the adjustment range covered by the variable capacitors C1 and C2 is allowed to be small; however, only a specific inductance may not be able to cover the fluctuation range of the impedance of the load.

Therefore, the number of switching taps is appropriately set in consideration of a design condition of an assumed fluctuation range of the impedance of the load, the capacitance and variable range of a usable capacitor, and the like.

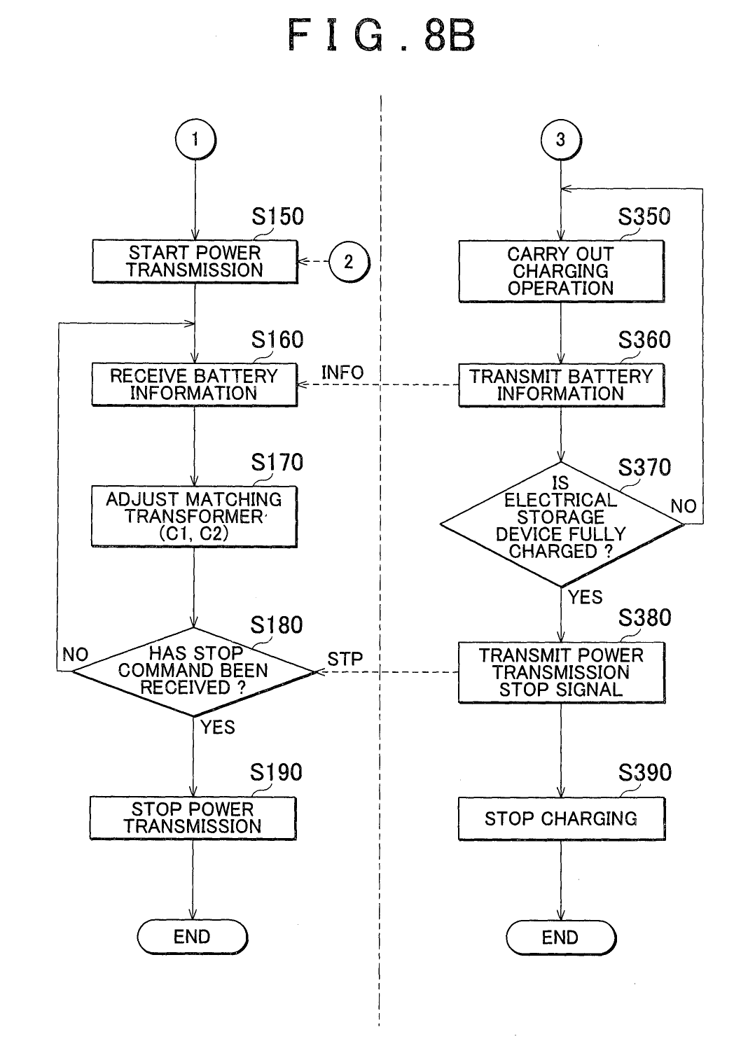

FIG. 8 is a flow chart for illustrating power supply control process executed by the power transmission ECU 240 and the vehicle ECU 300 in the first embodiment. The flow chart shown in FIG. 8 is implemented by executing programs prestored in the power transmission ECU 240 and the vehicle ECU 300 at predetermined intervals. Alternatively, for part of steps, the process may be implemented by constructing an exclusive hardware (electronic circuit).

First, the process executed by the vehicle ECU 300 of the vehicle 100 will be described. Referring to FIG. 2 and FIG. 8, when the vehicle 100 stops at a predetermined stop position above the power transmitting unit 220, the vehicle ECU 300 uses the communication unit 160 to start communication with the power transmitting device 200 in step (hereinafter, step is abbreviated as “S”) 300.

Then, when the ECU 300 receives the charge start signal TRG based on user's operation, or the like, in S310, the ECU 300 transmits the battery information INFO about the electrical storage device 190 to the power transmitting device 200 in S320. The battery information INFO includes a current SOC, information that indicates the impedance fluctuation range of the electrical storage device 190, and the like. Note that, in the power transmission ECU 240, as will be described later, initial adjustment of the matching transformer 260 is executed in response to the received battery information INFO.

After that, in S330, the vehicle ECU 300 closes the CHR 170 to prepare charging of the electrical storage device 190.

In S340, when the vehicle ECU 300 receives the adjustment completion flag COMP of the matching transformer 260 from the power transmission ECU 240, the vehicle ECU 300 transmits the power transmission start signal STRT to the power transmission ECU 240 in response to the received adjustment completion flag COMP. The power transmission ECU 240 starts power transmission operation in response to the received power transmission start signal.

When power transmission from the power transmitting device 200 is started, the vehicle ECU 300 uses received electric power to charge the electrical storage device 190 in S350.

In order to dynamically match a varying impedance of the electrical storage device 190 resulting from the progress of charging operation in the matching transformer 260 of the power transmitting device 200, the vehicle ECU 300 transmits the battery information INFO to the power transmission ECU 240 at predetermined time intervals in S350.

Then, the vehicle ECU 300 determines in S370 whether the electrical storage device 190 is fully charged.

When the electrical storage device 190 is not fully charged (NO in S370), the process returns to S350 and continues charging operation for charging the electrical storage device 190.

When the electrical storage device 190 is fully charged (YES in S370), the process proceeds to S380, and the vehicle ECU 300 transmits the power transmission stop signal STP to the power transmission ECU 240 to thereby stop power transmission operation. Although not shown in FIG. 8, for example, when charging is forcibly stopped by user's operation or when any abnormality has occurred in the vehicle 100, the power transmission stop signal STP may be transmitted even when the electrical storage device 190 is not fully charged.

After that, in response to the fact that power transmission from the power transmitting device 200 is stopped, the vehicle ECU 300 opens the CHR 170 to stop charging operation in S390.

Next, the process executed by the power transmission ECU 240 will be described. Referring back to FIG. 2 and FIG. 8, in response to the fact that the vehicle 100 is stopped at a predetermined stop position, the power transmission ECU 240 starts communication with the vehicle 100 using the communication unit 230 in S100.

When the power transmission ECU 240 receives the battery information INFO from the vehicle ECU 300 in S110, the inductance of the variable inductor L is adjusted as described in FIG. 7 on the basis of the impedance and impedance variation range of the side of the vehicle 100, determined from information included in the battery information INFO, and initial adjustment of the variable capacitors C1 and C2 is carried out such that the impedance of the side of the power transmitting device 200 coincides with the current impedance of the side of the vehicle 100 in S120.

Then, the power transmission ECU 240 determines in S130 whether initial adjustment of the matching transformer 260 has been completed.

When adjustment of the matching transformer 260 has not been completed (NO in S130), the process returns to S120, and adjustment of the matching transformer 260 is continued.

When adjustment of the matching transformer 260 has been completed (YES in S130), the process proceeds to S140, and the power transmission ECU 240 transmits the adjustment completion flag COMP of the matching transformer 260 to the vehicle ECU 300.

Then, in S150, in response to the fact that the power transmission start signal STRT has been received from the vehicle ECU 300, the power transmission ECU 240 controls the power supply unit 250 to start power transmission operation.

After that, in S160, the power transmission ECU 240 receives the battery information INFO from the vehicle ECU 300 while power transmission operation is being carried out. Then, the power transmission ECU 240 detects a variation in the impedance of the side of the vehicle 100 on the basis of the battery information INFO, and adjusts the variable capacitors C1 and C2 of the matching transformer 260 to bring the impedance of the side of the power transmitting device 200 into coincidence with the impedance of the side of the vehicle 100.

The power transmission ECU 240 determines in S180 whether the power transmission stop signal SPT has been received from the vehicle ECU 300.

When the power transmission stop signal SPT has not been received (NO in S180), the process returns to S160, and the power transmission ECU 240 continues power transmission operation while adjusting the matching transformer 260 until the power transmission stop signal SPT is received.

On the other hand, when the power transmission stop signal SPT has been received (YES in S180), the process proceeds to S190, and the power transmission ECU 240 stops power transmission operation.

By executing control in accordance with the above described process, it is possible to roughly adjust the matching transformer using the variable inductor so as to be able to cover the fluctuation range of the impedance of the side of the vehicle before power transmission operation is carried out, and it is possible to minutely adjust the impedance using the variable capacitor so as to bring the impedance of the side of the power transmitting device into coincidence with the impedance of the side of the vehicle while power transmission is being carried out. By so doing, it is possible to reduce a time required for impedance adjustment to reduce a charging time of the electrical storage device and to improve the transfer efficiency of electric power. Furthermore, in comparison with impedance adjustment using only the variable capacitor, the capacitance and variable range of the variable capacitor may be reduced, so it is possible to reduce the size and cost of the matching transformer as a whole.

### Second Embodiment

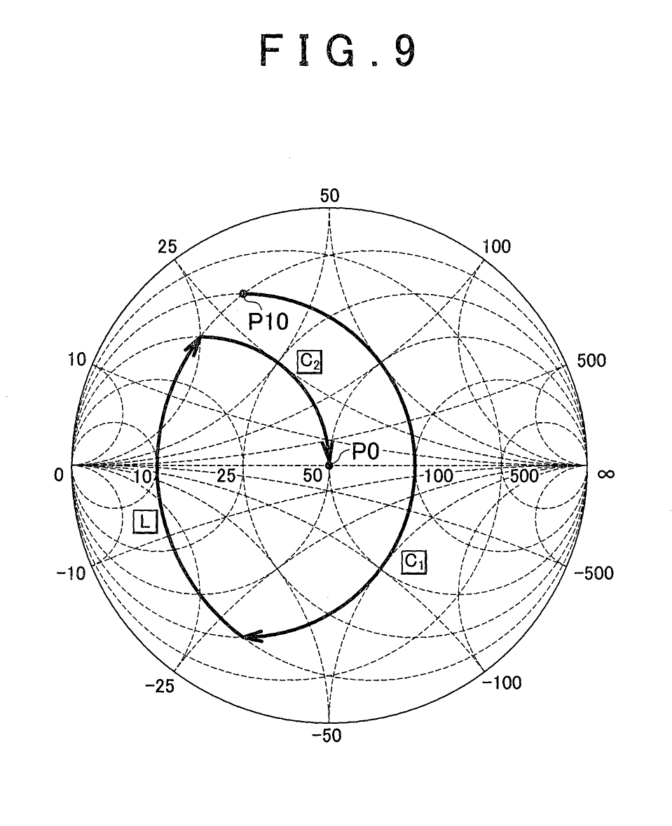

When the matching transformer is adjusted using the method described in the first embodiment, the capacitive imaginary part may be included in a load impedance at the side of the vehicle that is the load because of, for example, the capacitor for smoothing direct-current voltage rectified by the rectifier, the stray capacitance of a device, or the like. In such a case, as shown by point P10 in the Smith chart of FIG. 9, the load impedance is placed on the upper side (positive side) with respect to the horizontal axis of the Smith chart.

In this case, depending on the variable range of the variable inductor and the variable range of the variable capacitor C2, the variable range of the variable capacitor C1 may be required to be extremely increased.

However, as described above, a large-capacitance capacitor is expensive and there is a small number of types of large-capacitance capacitor that has a favorable characteristic at high frequencies, so the impedance may not be appropriately matched within the variable range of the usable variable capacitor C1 selected in terms of cost and performance.

Then, in the second embodiment, the configuration of a matching transformer that includes an additional capacitor, which may be selectively connected in parallel with the variable capacitor C1, and that may be matched in impedance to a load even when a capacitance that exceeds the variable range of the variable capacitor C1 is required will be described.

FIG. 10 is a detailed configuration view of a matching transformer 260A according to the second embodiment. The matching transformer 260A shown in FIG. 10 is configured such that a capacitance adding portion 268 is added to the matching transformer 260 described in FIG. 5 in the first embodiment. In FIG. 10, the description of the elements that overlap with those of FIG. 5 is not repeated.

The capacitance adding portion 268 includes at least one additional capacitor. FIG. 10 shows an example in which two additional capacitors C11 and C12 are included; instead, it may be configured to include only the capacitor C11 or may be configured to include more than two capacitors. In addition, the capacitors included in the capacitance adding portion 268 may be fixed-capacitance capacitors, such as the capacitors C11 and C12, or may be variable capacitors, such as the capacitors C1 and C2. Note that the capacitances of the capacitors C11 and C12 are appropriately set on the basis of a required adjustment range, and those may be the same capacitance or may be different capacitances.

The capacitor C11 together with a serially connected switch SW11 is connected in parallel with the variable capacitor C1. In addition, the capacitor C12 together with a serially connected switch SW12 is connected in parallel with the variable capacitor C1.

When a capacitance that exceeds the variable range of the variable capacitor C1 is needed, the switches SW11 and SW12 are selectively switched between a conductive state and a non-conductive state by the power transmission ECU 240 on the basis of the excess of capacitance.

In this way, the matching transformer is configured to have an additional capacitor that may be selectively connected to the variable capacitor to thereby make it possible to handle a further large fluctuation of a load impedance.

Note that, in the above description, an example in which a capacitor is selectively added to the variable capacitor C1 is described; however, when it is required to increase the variable range of the variable capacitor C2, the above described capacitance adding portion may be provided for the variable capacitor C2.

In the present embodiment, the case where the matching transformer is provided for the power transmitting device will be described; instead, the matching transformer may be provided for the vehicle side (power receiving side). In addition, in the above description, the case where electric power is supplied from the power transmitting device to the vehicle is described; however, even when electric power from the electrical storage device of a vehicle is supplied to a system power supply side as in the case of a smart grid, the aspect of the invention may be applied in order to match the impedance of a power transmitting side to the impedance of a power receiving side.

In addition, in the above description, an example in which the power transmitting unit and the power receiving unit include the resonance coils and electromagnetic induction coils (the primary coil and the secondary coil) is described; instead, the aspect of the invention may also be applied to a resonance system that is configured such that the power transmitting unit and the power receiving unit have no electromagnetic induction coils. In this case, in FIG. 2, at the side of the power transmitting device 200, the primary resonance coil 221 is coupled to the matching transformer 260 without intervening the primary coil 223, and, at the side of the vehicle 100, the secondary resonance coil 111 is coupled to the rectifier 180 without intervening the secondary coil 113.

The embodiments described above are illustrative and not restrictive in all respects. The scope of the invention is defined by the appended claims rather than the above description. The scope of the invention is intended to encompass all modifications within the scope of the appended claims and equivalents thereof.

1. A power transmitting device for contactlessly transferring, electric power to a power receiving device through electromagnetic resonance, comprising:
a power transmitting unit configured to carry out electromagnetic resonance with a power receiving unit included in the power receiving device to transfer electric power;
a power supply unit configured to supply electric power to the power transmitting unit;
a matching transformer coupled between the power supply unit and the power transmitting unit, the matching transformer including a variable inductor and a variable capacitor that adjust an impedance of the power transmitting device; and
a control unit configured to control the matching transformer, wherein
the control unit is configured to control the matching transformer to bring the impedance of the power transmitting device close to the impedance of the power receiving device by adjusting the variable inductor, before starting transfer of electric power, on the basis of a signal which indicates an impedance of the power receiving device and which is transmitted from the power receiving device.

2. The power transmitting device according to claim 1, wherein
the variable inductor is connected in series with the power transmitting unit and the power supply unit between the power transmitting unit and the power supply unit.

3. The power transmitting device according to claim 1, wherein
the variable capacitor is connected in parallel with the power transmitting unit and the power supply unit between the power transmitting unit and the power supply unit.

4. The power transmitting device according claim 1, wherein during transfer of electric power, the control unit adjusts the variable capacitor in response to a variation in the impedance of the power receiving device to control the matching transformer so as to match the impedance of the power transmitting device to the impedance of the power receiving device.

5. The power transmitting device according to claim 1, wherein
the matching transformer has first and second capacitors as the variable capacitor,
the variable inductor is connected between the power transmitting unit and the power supply unit,
the first capacitor is connected to a first end portion of the variable inductor,
the first end portion is connected to the power transmitting unit,
the second capacitor is connected to a second end portion of the variable inductor, and
the second end portion is connected to the power supply unit.

6. The power transmitting device according to claim 5, wherein
the matching transformer includes a third capacitor that is provided in parallel with the first capacitor and that is configured to be selectively connected to the first capacitor.

7. The power transmitting device according to claim 6, wherein
the matching transformer includes a switch that is connected in series with the third capacitor and that connects or disconnects the third capacitor connected in parallel with the first capacitor.

8. The power transmitting device according to claim 1, wherein
the control unit is configured to transmit a first signal that indicates completion of the adjustment to the power receiving device when adjustment of the variable inductor has been completed, and
the power receiving device is configured to output a second signal, which indicates instructions to start transfer of electric power, to the power transmitting device after receiving the first signal.

9. The power transmitting device according to claim 1, wherein the matching transformer includes a switching unit that switches an inductance of the variable inductor.

10. A power receiving device for contactlessly receiving electric power, transferred from a power transmitting device, through electromagnetic resonance, the power transmitting device including a power transmitting unit; a power supply unit that supplies electric power to the power transmitting unit; and a matching transformer that is, coupled between the power supply unit and the power transmitting unit and that has a variable inductor and a variable capacitor for adjusting an impedance of the power transmitting device, comprising:
a power receiving unit configured to carry out electromagnetic resonance with the power transmitting unit to receive electric power from the power transmitting device;
an electrical storage device configured to be charged with the received electric power; and
a control unit configured to control charging operation for charging the electrical storage device, wherein
the control unit is configured to output a signal that indicates an impedance of the power receiving device to the power transmitting device, and causes the power transmitting device to adjust the matching transformer so as to bring the impedance of the power transmitting device close to the impedance of the power receiving device by adjusting the variable (inductor before starting transfer of electric power from the power transmitting device.

11. A vehicle comprising:
the power receiving device according to claim 10; and
a driving device configured to use electric power from the electrical storage device according to claim 10 to generate running driving force.

12. A contactless power supply system for contactlessly transferring electric power through electromagnetic resonance, comprising:
a power transmitting device that includes a power transmitting unit;
a power receiving device that includes a power receiving unit that carries out electromagnetic resonance with the power transmitting unit; and
a control unit configured to control transfer of electric power from the power transmitting device to the power receiving device, wherein
the power transmitting device includes a power supply unit that supplies electric power to the power transmitting unit and a matching transformer that is coupled between the power supply unit and the power transmitting unit and that includes a variable inductor and a variable capacitor that adjust an impedance of the power transmitting device, and
the control unit is configured to control the matching transformer to bring the impedance of the power transmitting device close to the impedance of the power receiving device by adjusting the variable inductor, before starting transfer of the electric power, on the basis of a signal that indicates an impedance of the power receiving device and that is transmitted from the power receiving device.

13. A method of controlling a contactless power supply system that includes:
a power transmitting device that includes a power transmitting unit; a power supply unit that supplies electric power to the power transmitting unit; and a matching transformer that is coupled between the power supply unit and the power transmitting unit and that includes a variable inductor and a variable capacitor that adjust an impedance of the power transmitting device; and
a power receiving device that includes a power receiving unit that carries out electromagnetic resonance with the power transmitting unit to contactlessly receive electric power from the power transmitting unit, the method comprising:
before starting transfer of electric power from the power transmitting device to the power receiving device, bringing the impedance of the power transmitting device close to the impedance of the power receiving device by adjusting the variable inductor on the basis of an impedance of the power receiving device.
